(19) United States
(12) Patent Application Publication
(10) Pub. No.: US 2010/0051058 A1
(43) Pub. Date: Mar. 4, 2010

(54) Automated Mat Cleaning and Handling System and Method

(76) Inventors: Robert Cotter, Batavia, OH (US); Randy Pound, Wilmington, OH (US); John Milligan, Cincinnati, OH (US)

Correspondence Address: FROST BROWN TODD, LLC, 2200 PNC CENTER, 201 E. FIFTH STREET, CINCINNATI, OH, 45202, US

(21) Appl. No.: 12/487,396

(22) Filed: Jun. 18, 2009

Related U.S. Application Data
(60) Provisional application No. 61/059,952, filed on Jun. 18, 2008.

(51) Int. Cl. B08B 7/04; B65G 27/00; F26B 9/00

(52) U.S. Cl. 134/18; 198/752.1; 34/164; 134/115 R

(57) ABSTRACT

An automated system is configured to wash and dry mats. The system includes a number of modules, including a loading module, vibration module, washing module, vacuum module, and a discharge module. The disclosed system provides an opportunity for manual inspection of the mats, too. Because the mats that are fed into the system are jostled or shaken before they are washed, reduced amounts of chemicals, water, water pressure, drying energy, etc. are needed to clean the mats. The system may also optionally include a automatic rolling and sorting apparatus, which rolls a mat and sorts it according to weight, size, etc. after it is discharged from the discharge module. A method of cleaning mats is also disclosed.

### PRIORITY

This application claims priority to and benefit of U.S. Provisional Application No. 61/059,952, filed on Jun. 18, 2008, which is herein incorporated by reference in its entirety.

### FIELD

Embodiments of the present invention relate, in general, to a mat handling assembly and a method for using the same. In particular, embodiments of the invention relate to a system and method for cleaning mats.

### BACKGROUND

Many industries rely upon mats to improve the sanitary conditions of the workplace and to enhance the working environment for workers. For example, floor mats may be used in food service, manufacturing, and health care settings to reduce leg and lower back strain, decrease incidence of injuries due to slipping and fatigue, and limit biological and chemical contamination and pest infestation. Conventional equipment and techniques used to clean mats may require awkward manual manipulation of the mats, which may generate back strain or other injury in workers. In addition, conventional cleaning systems may be wasteful of both time and energy. Due to these limitations, prior art cleaning equipment and techniques may inhibit the efficiency with which mats and screens are properly cleansed, and in some cases, conventional practices may actually degrade the sanitary quality of a work place, public area, or dwelling.

Thus, it may be advantageous to provide a system and method for cleaning mats that is more energy-efficient by reducing the amount of chemicals, water, and energy used to wash and dry the mats. It may also be advantageous for a mat-cleaning system to improve worker safety by having an ergonomic design and by reducing the number of workers needed to operate the system. Furthermore, it may be advantageous if the mat-cleaning system extends the product life of the mats by reducing wear and providing an opportunity for quality control. Wear and tear on the mats may be reduced by reducing the handling of the mats and/or by lowering the water or fluid pressure when cleaning the mats.

While several systems and methods have been made and used for cleaning mats, it is believed that no one prior to the inventors has made or used the invention described in the appended claims.

### Broad Claim

### BRIEF DESCRIPTION OF THE DRAWINGS

While the specification concludes with claims which particularly point out and distinctly claim the invention, it is believed the present disclosure will be better understood from the following description of certain examples taken in conjunction with the accompanying drawings. In the drawings, like numerals represent like elements throughout the several views.

FIG. 1 depicts an exemplary mat-cleaning system.

FIG. 2 depicts the loading and vibrating modules of the mat-cleaning system of FIG. 1.

FIG. 3 depicts a front view of an air float table.

FIG. 4 depicts a top view of the air float table of FIG. 3.

FIG. 5 depicts a beat roller assembly engaged with a dirty mat.

FIG. 6 depicts an isometric view of a beat roller assembly.

FIG. 7 depicts an isometric view of a beat roller.

FIG. 8 depicts a front view of a beat roller.

FIG. 9 depicts a side view of a beat roller.

FIG. 10 depicts a front view of a beat roller assembly.

FIG. 11 depicts a side view of a beat roller assembly.

FIG. 12 depicts a front view of a support plate.

FIG. 13 depicts a side view of a shaft.

FIG. 14 depicts an isometric view of a bushing.

FIG. 15 depicts a side view of a bushing.

FIG. 16 depicts a front view of a bushing.

FIG. 17 depicts the washing module of the mat-cleaning system of FIG. 1.

FIG. 18 depicts an isometric view of an exemplary washing module.

FIG. 19 depicts the drying module of the mat-cleaning system of FIG. 1.

FIG. 20 depicts an isometric view of a vacuum nozzle.

FIG. 21 depicts a side view of the vacuum nozzle block of FIG. 20.

FIG. 22 depicts a cross-sectional view of the vacuum nozzle block of FIG. 20, along line A-A.

FIG. 23 depicts an mounting hole in the vacuum nozzle block of FIG. 20.

FIG. 24 depicts a groove and a mounting hole in the vacuum nozzle block of FIG. 22.

FIG. 25 depicts a corner of the vacuum nozzle block of FIG. 22.

FIG. 26 depicts a vacuum nozzle tube seal and two nozzle blocks engaged with a wire belt conveyor.

FIG. 27 depicts a front view of a belt support.

FIG. 28 depicts a side view the belt support

FIG. 29 depicts a hot air dryer according to one embodiment.

FIG. 30 depicts the discharge module of the mat-cleaning system of FIG. 1.

FIG. 31 depicts an exemplary dual action conveyor.

FIG. 31 depicts an isometric view of the dual action conveyor of FIG. 31.

FIG. 32 depicts a discharge apparatus.

FIG. 33 depicts a mat-cleaning system, according to another embodiment.

FIG. 34 depicts the loading, vibration, washing, and drying modules of the mat-cleaning system of FIG. 33.

FIG. 35 depicts the drying and discharge modules of the mat-cleaning system of FIG. 33.

FIG. 36 depicts a mat-cleaning system, according to another embodiment.

FIG. 37 depicts a flow diagram of a method of cleaning a mat.

### DETAILED DESCRIPTION

The following description of certain examples of the application should not be used to limit the scope of the present invention. Other examples, features, aspects, embodiments, and advantages of the application will become apparent to those skilled in the art from the following description, which is by way of illustration, one of the best methods contemplated for carrying out the invention. As will be realized, the invention is capable of other different and obvious aspects, all without departing from the invention. Accordingly, the drawing and descriptions should be regarded as illustrative in nature and not restrictive.

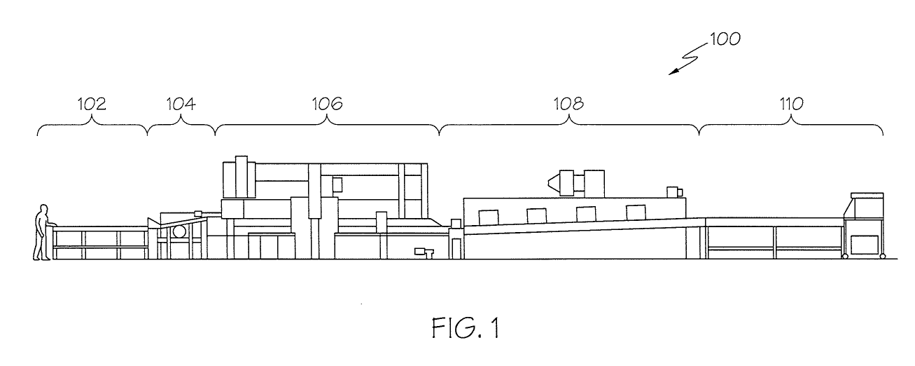

Examples described herein relate to the cleaning of rugs or mats, or other similar generally flat objects that require periodic maintenance, and more particularly to systems and methods for industrial mat cleaning. More specifically, the current application discloses a system and method for cleaning and processing mats. As used herein, the term “mat” will refer to any flat object suitable for use in the disclosed cleaning system and by the proposed methodology, including but not limited to industrial floor mats, rugs, or other flat objects. In addition, as used herein, the term “dirt” will refer to any debris present on or in the mat being cleaned by the system (100), including but not limited to dirt, debris, dust, or any other particles or unwanted matter. A shown in FIG. 1, one embodiment of a mat cleaning system (100) comprises one or more modules, including but not limited to a loading module (102), a vibration module (104), a washing module (106), a drying module (108), and a discharge module (110). Each mat being cleaned is directed through each module. Although this embodiment discloses the module(s) in a particular order, it should be appreciated that a mat may be directed through the module(s) in any suitable order. For example, vibration module (104) may come after washing module (106). The modules comprising mat cleaning system (100) will be discussed further below.

### I. Loading Module

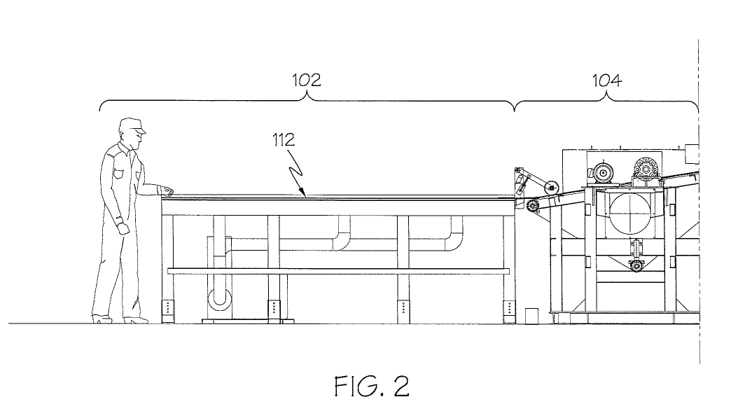

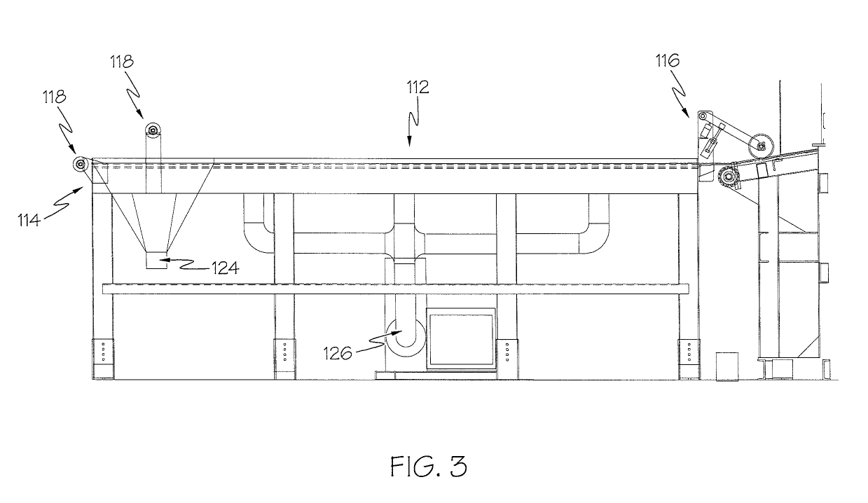

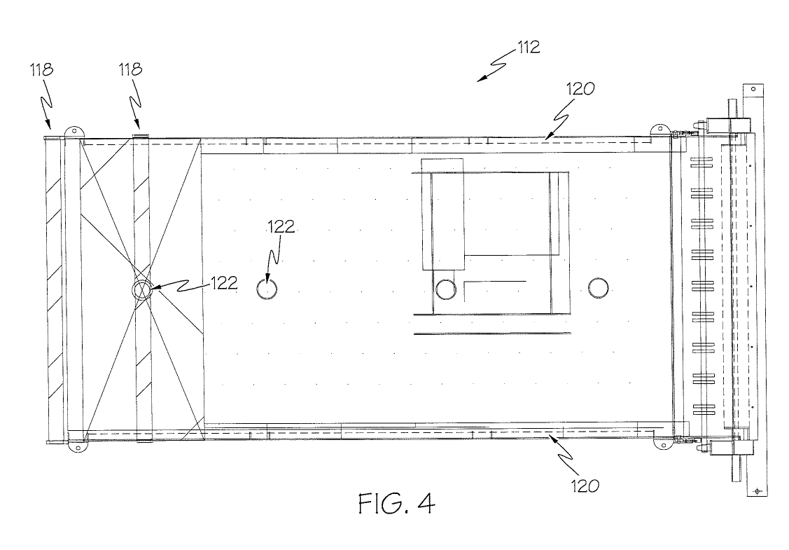

FIG. 2 shows a loading module (102) of the system (100) shown in FIG. 1. Loading module (102) may comprise an air-float table (112) upon which a mat can be placed. As will be apparent to one of ordinary skill in the art, any other suitable table, conveyor, or an equivalent may be used to transport a mat through the system (100). For example, table (112) may be a gravity conveyor, which uses gravity to feed the mat through the module. The table (112) may have a first end (114) for loading the mats and a second end (116) that engages with the next module, which in the present embodiment is vibration module (104). As shown in FIGS. 3-4, table (112) may also comprise a number of features to facilitate the loading and cleaning of the mats. For example, table (112) may comprise one or more load rollers (118), which may rotate to assist a user in loading a mat into the system (100). Load rollers (118) may also help straighten and/or flatten the mat as it is fed onto table (112). Although load rollers (118) are positioned near the first end (114) of table (112) in the present example, it will be appreciated that a roller (118) may be located in any other suitable location along table (112). In addition to the load rollers (118), table (112) may comprise one or more edge guides (120) located along an edge of the table (112) to help guide the loaded mat along the table (112).

Any suitable mat may be loaded into system (100). The dimensions of the mats that can be cleaned by the system (100) may depend on the dimensions of system (100). For example, in the present embodiment, any mat with a width up to five feet may be fed into the system (100). Larger sized mats may be loaded into other versions of system (100). A mat may comprise at least two surfaces, an underside and a pile side. The pile side may be the side of the mat generally exposed during use of the mat. The mat may be fed into system (100), and more particularly into loading module (102), in any suitable manner as will be apparent to one of ordinary skill in the art. For example, to best clean the pile side of a mat, the mat may be loaded with the pile side positioned down towards table (112).

As shown in the present example, air-float table (112) may further comprise a plurality of apertures (122) through which air may be blown to easily and ergonomically feed the mat through the module (102) and into the next module. In another example, at least a portion of the surface of table (112) may also comprise a grid, screen, or gravity conveyor defining a plurality of open apertures through which dirt may fall. In this way, as a mat is loaded onto table (112), any dirt shaken from the mat during the loading process may fall through apertures (122) to be collected by a collection trough (124) that may be situated beneath table (112). In addition to collecting any dirt that happen to leave the mat as it is loaded, collection trough (124) may also collect any dirt that is blown off the loaded mat by way of a blower (126), which may be situated underneath of table (112). Blower (126) may be directed to blow air from the underside of table (112) and through apertures (122) to dislodge the dirt on the loaded mat. Blower (126) may also be used with an air-float table (112) to assist in feeding the mat to a next module in the system.

In addition to loading and positioning a mat onto table (112), loading module (102) may comprise a quality control inspection, which may be performed prior to or during the loading process. Any suitable quality control inspection may be used. For example, the quality control inspection may include a review of the mat for tears, stains, worn spots, or any other quality-related issues. The inspection may include inspecting both sides of the entire mat. Alternatively, the inspection may only include inspecting either the pile side or the underside of the mat. Even further, the inspection of the pile side of the mat may occur prior to flipping the mat pile side down and feeding the mat onto table (112). Inspection of the underside portion of the mat may occur after loading the mat onto the air-float table (112) pile side down. Moreover, a quality control inspection may also include the pretreatment of stains or spots on the mat and/or the removal of damaged mats from the system (100).

Of course, the above-described loading module (102) is merely one example. Any other suitable type of loading module (102) and associated components may be used. By way of example only, loading module (102) may also comprise laser sights, which may be used to detect a wavy or rumpled mat that may need to be straightened before further transport through system (100). Alternatively, loading module (102) may have any other suitable components, features, configurations, functionalities, operability, etc. Other suitable variations of loading module (102) and associated components will be apparent to those of ordinary skill in the art in view of the teachings herein.

### II. Vibration Module

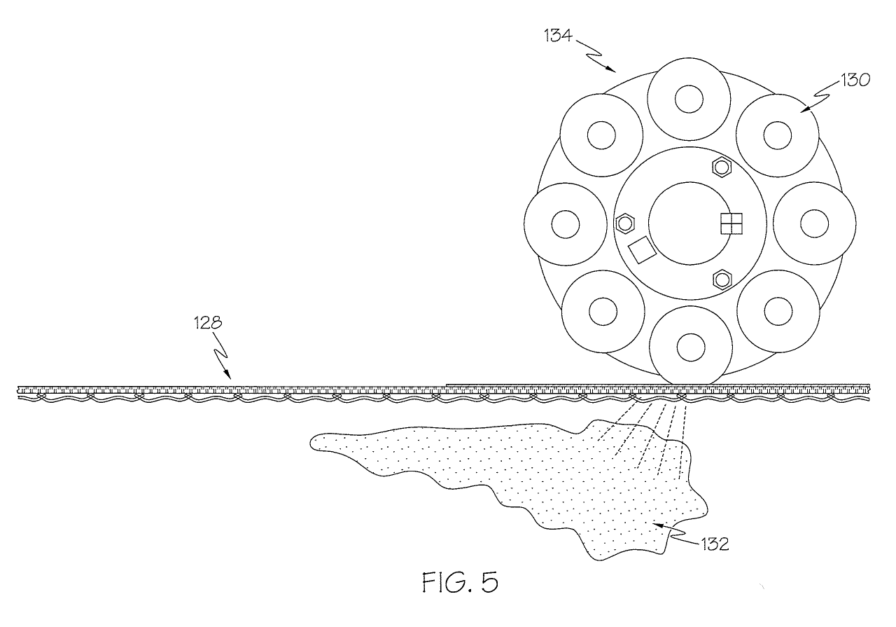

In addition to a loading module (102), the mat cleaning system (100) of the present example may also comprise a vibration module (104) as shown in FIG. 2. For example, after feeding a mat into system (100) using the loading module (102), and preferably after a quality control inspection has occurred, the mat may be directed at the second end (116) of table (112) to the vibration module (104). As shown in FIG. 5, vibration module (104) may comprise a conveyor (128) and at least one beat roller (130). After being fed through the loading module (102), the mat may be positioned onto the conveyor (128). Conveyor (128) may be used to transport the mat through system (100).

During operation, as shown in FIG. 5, the at least one beat roller (130) and conveyor (128) engage the mat so as to dislodge any dirt (132) that is present on or in the mat. For example, a beat roller (130) may contact the mat simultaneously with or subsequent to the movement of the mat by the conveyor (128). As shown in FIG. 5, the beat roller (130) may contact the mat on its underside or, alternatively, on its pile side. Having the beat roller (130) contact the mat may loosen as well as dislodge dirt from the mat. Conveyor (128) may not only be used to transport the mat through system (100), but may also, through an opening on the conveyor (128), permit the collection of any dirt that may be loosened or dislodged from the mat during the vibratory action caused by a beat roller (130). It will be appreciated that any suitable vibration frequency of module (104) may be used to shake off or dislodge the dirt from the mat. In one embodiment, the vibration frequency is at least 60 Hz and adjustable to 120 Hz. Preferably, the frequency ranges from 70-100 Hz. The optimal vibration frequency of module (104) may be determined by the number of beat rollers (130) included in vibration module (104), as well as the corresponding rotation speed of the module (104). FIGS. 5-6 disclose an exemplary beat roller assembly (134), which may comprise at least one beat roller (130) and various other components.

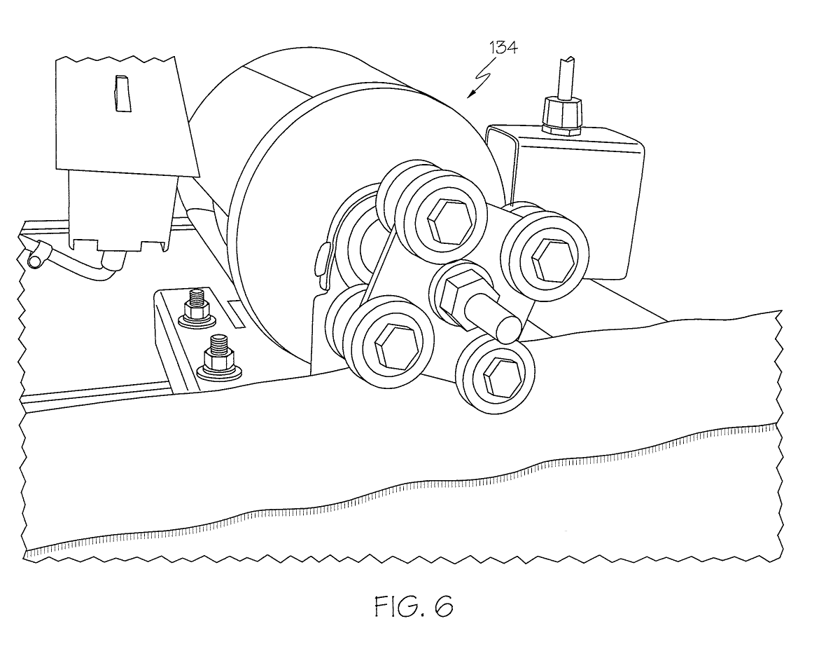

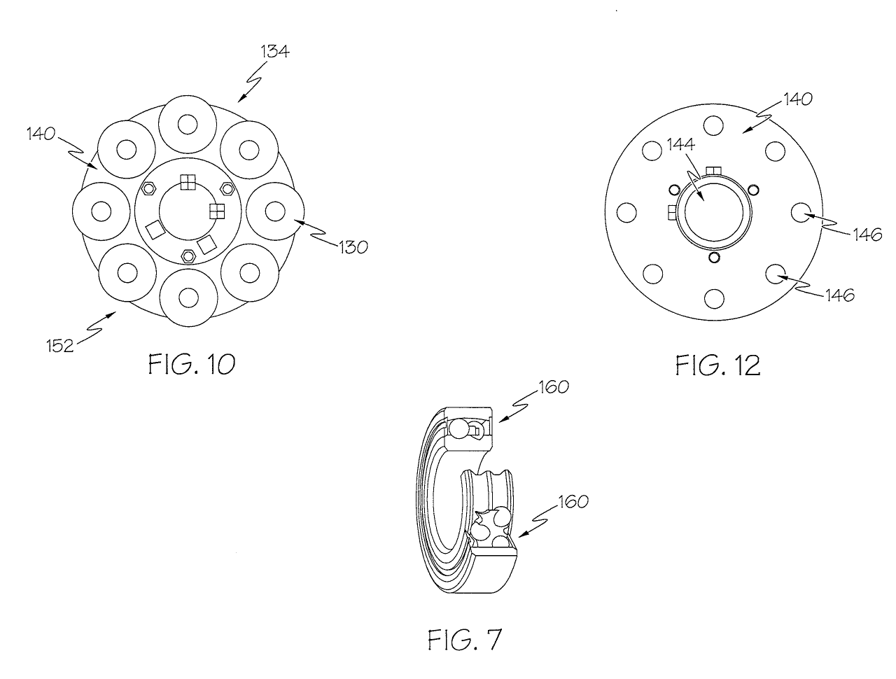

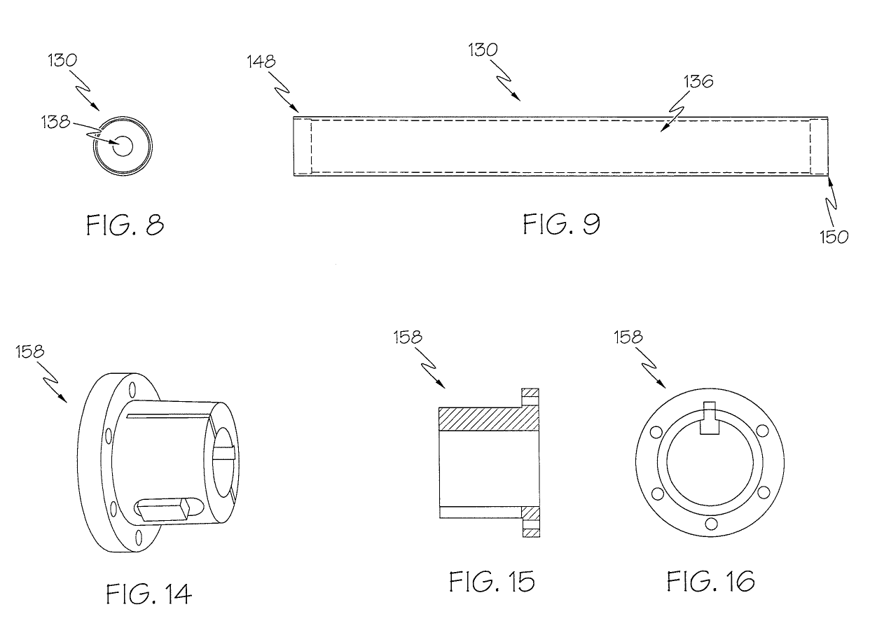

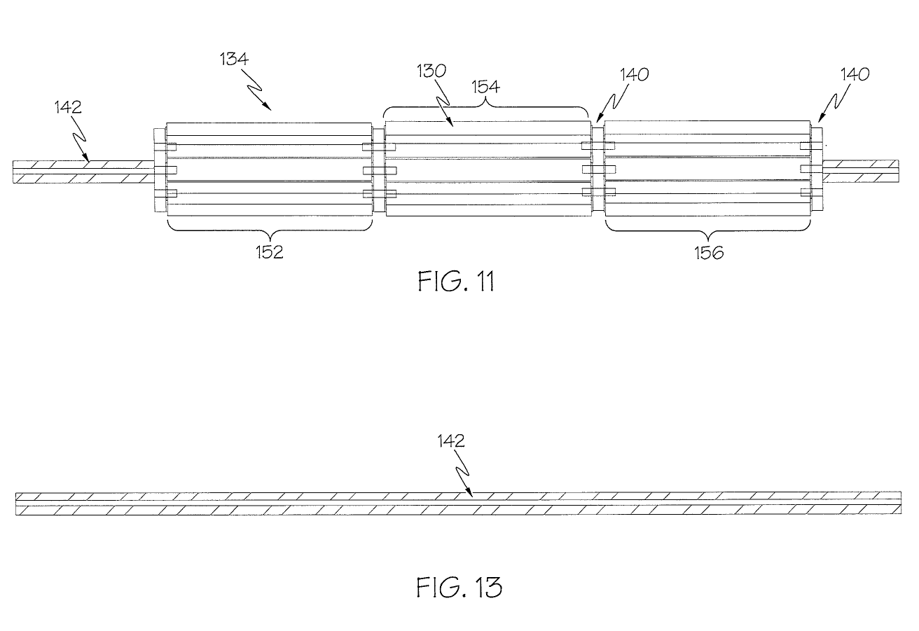

One example of a beat roller (130) is shown in FIGS. 7-9. Beat roller (130) may comprise a pair of sealed, high speed bearings (160) and a generally cylindrical shaft (136) that defines a central cavity or bore (138). FIGS. 10-11 depict a beat roller assembly (134) comprising a plurality of beat rollers (130). A single beat roller (130) or an assembly (134) may be used in vibration module (104) to loosen and/or dislodge dirt from the mat. In addition to the beat rollers (130), a beat roller assembly (134) may further comprise a support plate (140) and a shaft (142). Support plate (140) may be a generally circular plate of suitable thickness having a central cavity (144) surrounded by one or more periphery holes (146), as shown in FIG. 12. Shaft (142), having a generally cylindrical shape as shown in FIG. 13, may be positioned through the central cavity (144) in support plate (140). A beat roller (130), having a first end (148) and a second end (150) may be placed end to end between two support plates (140) and secured by the placement of one or more fasteners, such as a dowel, through the one or more periphery holes (146) in the support plates (140).

In addition, a beat roller assembly (134) may comprise a bushing (158) like that shown in FIGS. 14-16. Such a bushing (158) may be positioned through the central cavity (144) of support plate (140) to facilitate the positioning of shaft (142). A bushing (158) may be positioned through each support plate (140) included in assembly (134).

In this way, a beat roller assembly (134) may be assembled having a plurality of beat rollers (130) positioned between a plurality of support plates (140) that are secured together by a central shaft (142) that extends through the cavities (144) in the support plates (140). The beat roller assembly (134) may comprise any number of beat rollers (130) and support plates (140). For example, as depicted in FIGS. 10 and 11, the assembly (134) comprises four support plates (140) and a total of twenty-four beat rollers (130). The twenty-four beat rollers (130) in the assembly (134) are divided into three groups (152, 154, and 156) of eight, where eight beat rollers (130) are positioned around shaft (142) and between any two support plates (140). The first group (152) of eight beat rollers (130) is shown in FIG. 10. As will be appreciated by one of ordinary skill in the art, beat roller assembly (134) may comprise any number of beat rollers (130) and support plates (140). By way of example only, FIGS. 10-11 show an assembly (134) comprising twenty-four beat rollers (130) and four support plates (140). In addition, vibrating module (104) may comprise any number of beat roller assemblies (134).

During operation, a beat roller assembly (134) may pulse and/or rotate along the conveyor (128) to dislodge or loosen the dirt on a mat. The optimal pulse depth of a beat roller assembly (134) may be determined by the number of beat rollers (130) included in the beat roller assembly (134). A pulse depth may average, for example, 0.100 inches, and the pulse depth may be adjustable depending on the mat being cleaned by the system. A beat roller (130) and/or a beat roller assembly (134) may contact the mat on the conveyor (128). Alternatively, the beat roller (130) and/or beat roller assembly (134) may contact the underside of the conveyor (128).

Vibration module (104) may further comprise an apparatus to collect the dirt being shaken or loosened from the mat. Any suitable apparatus may be used and positioned in any suitable manner. For example, a pan may be positioned underneath the conveyor (128) in alignment with the beat rollers (130). The pan may collect any dirt dislodged from the mat due to the movement of conveyor (128) and/or contact with the beat rollers (130). Even further, a dirt collector may be positioned below and along the length of the vibration module (104).

Of course, the above-described vibration module (104) is merely one example. Any other suitable type of vibration module (104) and associated components may be used. By way of example only, vibration module (104) may also comprise a vacuum to transport the dirt away from the system (100).

Alternatively, vibration module (104) may have any other suitable components, features, configurations, functionalities, operability, etc. Other suitable variations of vibration module (104) and associated components will be apparent to those of ordinary skill in the art in view of the teachings herein.

### III. Washing Module

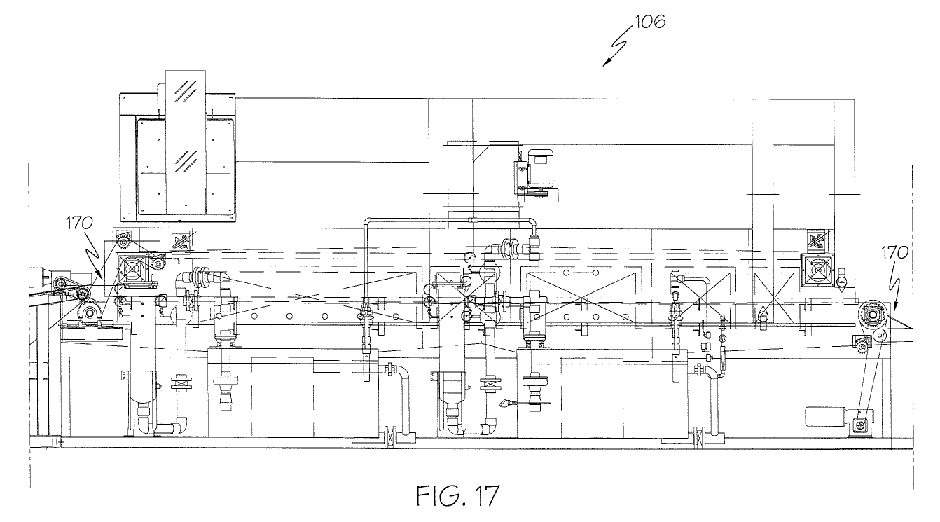

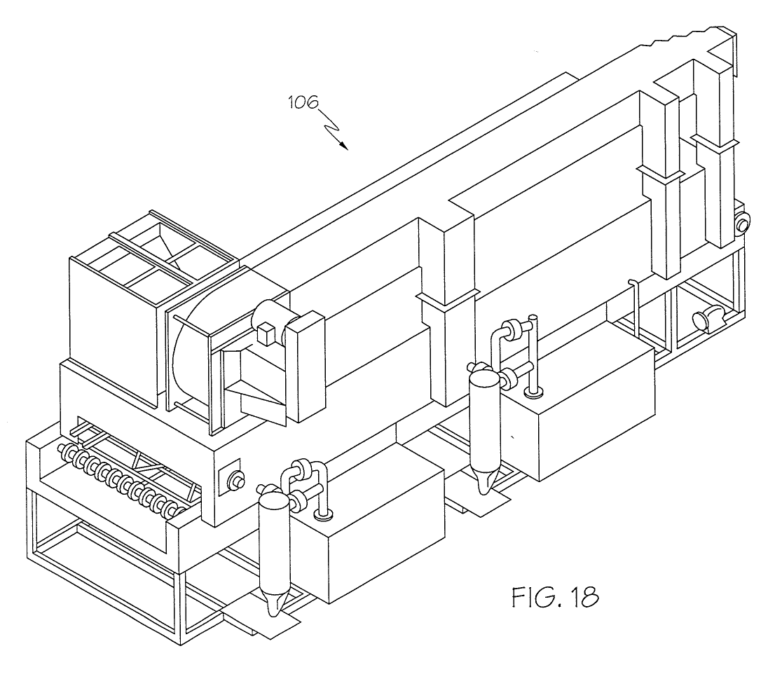

In the present embodiment, mat cleaning system (100) may further comprise a washing module (106) as shown in FIG. 17-18. For example, after traveling through vibration module (104) on the conveyor (128), the mat may next travel to the washing module (106). Washing module (106) may comprise a conveyor (170), which may or may not be the same conveyor (128) from the vibration module (104). Furthermore, washing module (106) may comprise one or more devices for washing and/or rinsing the mat.

One exemplary process for washing the mat comprises first washing the mat with a chemical-based wash using a high-volume, low-pressure spray nozzle to further clean the mat and dislodge any remaining unwanted matter. Advantageously, because a significant amount of dirt may be removed in the vibration module (104), a relatively lower amount of chemical wash may be required as compared with prior art cleaning processes. Further, because the mat is already partially cleaned in the loading and vibration modules (102, 104), a low-pressure wash may be used, which reduces the amount of wear to the mat being cleaned. The mat preferably may also be rinsed with a high-volume, low-pressure fresh water rinse. Although a low-pressure wash is disclosed, higher pressures could be used within the scope of this disclosure, as will be appreciated by one of ordinary skill in the art. Water may be reused and recycled in the washing module (106). The reused water may be collected in any suitable manner. The recycled water may be cleaned prior to its future use. In addition, after washing and rinsing the mat, washing module (106) may comprise a blow off, wherein excess water or chemical agent remaining after the wash and rinse may be blown off the mat with a blower. In addition to water, other agents may be used to clean and/or rinse the mat, including but not limited to detergents, anti-static agents, anti-stain agents, deodorants, perfumes, etc.

It will be appreciated that the temperature of the washing and rinsing in module (106) may be varied. For example, because the present system (100) involves feeding a mat through a vibration module (104) wherein dirt is dislodged from the mat prior to feeding it through a washing module (106), a lower temperature wash and/or rinse may be effective to clean the mat. Furthermore, a person of ordinary skill in the art will appreciated that either or both sides of a mat may be washed and/or rinsed in the washing module (106). In addition, washing module (106) may comprise an anti-flip roller bar situated at one end of conveyor (170) to prevent or restrict a mat from flipping over.

Of course, the above-described washing module (106) is merely one example. Any other suitable type of washing module (106) and associated components may be used. By way of example only, washing module (106) may comprise a high-volume, low-pressure blow off, whereby air is blown around the mat to remove any chemical wash and/or water remaining on the mat. Alternatively, or in addition, the drying module (108) may comprise this blow off stage. Washing module (106) may have any other suitable components, features, configurations, functionalities, operability, etc. Other suitable variations of washing module (106) and associated components will be apparent to those of ordinary skill in the art in view of the teachings herein.

### IV. Drying Module

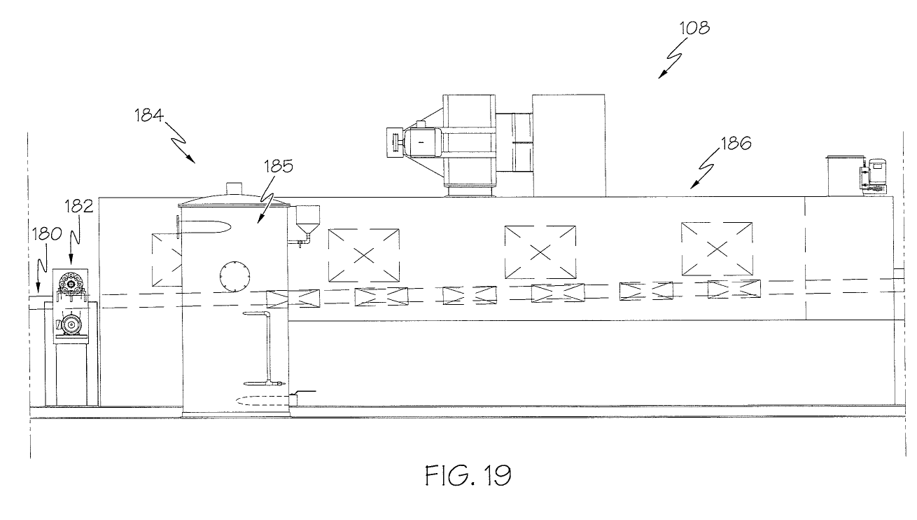

In addition to a loading module (102), a vibration module (104), and a washing module (106), the present example of a mat cleaning system (100) may comprise a drying module (108). For example, after a mat is fed through washing module (106), it may proceed along to the drying module (108) to be dried. As shown in FIG. 19, drying module (108) may further comprise a conveyor (180), a vibratory beater (182), a vacuum (184), and a dryer (186). Drying module (108) may include any one of those features either separately or in any suitable combination. For example, drying module (108) may consist solely of a vibratory beater (182) and a vacuum (184). Conveyor (180) may be similar or identical to the conveyor (128) of the vibration module (104). During drying module (108), the mat may encounter a vibratory beater (182), which may contact the mat to shake off any chemical wash and/or water rinse remaining on the mat from the washing module (106). Vibratory beater (182) may be identical to the beat roller (130) or beat roller assembly (134) described in the vibration module (104). Vibratory beater (182) may contact the mat on the conveyor (180) or it may contact the underside of the conveyor (180). Module (108) may vibrate at a given frequency to jostle the mat and shake off any chemical wash and/or water rinse remaining on or in the mat from the washing module (106). Any suitable vibration frequency may be used. In one embodiment, the vibration frequency is at least 60 Hz and adjustable to 120 Hz. Preferably, the frequency ranges from 70-100 Hz.

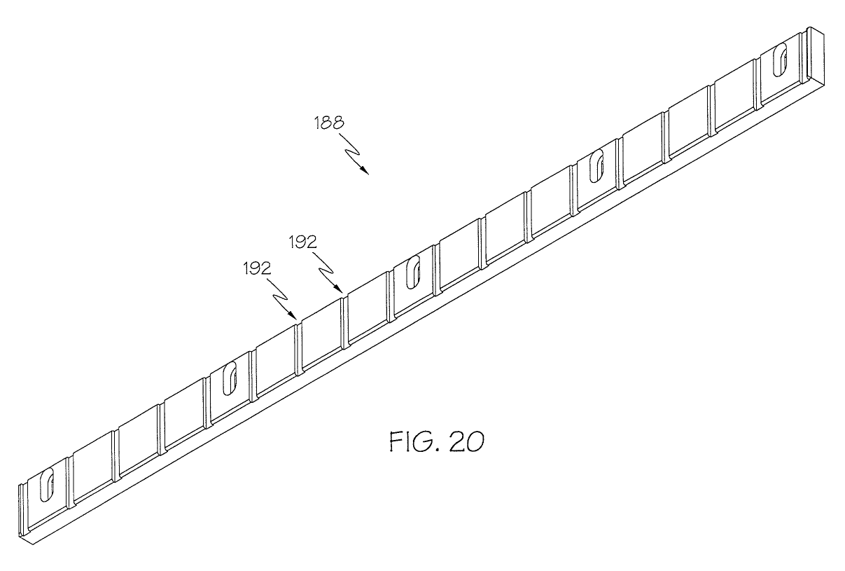

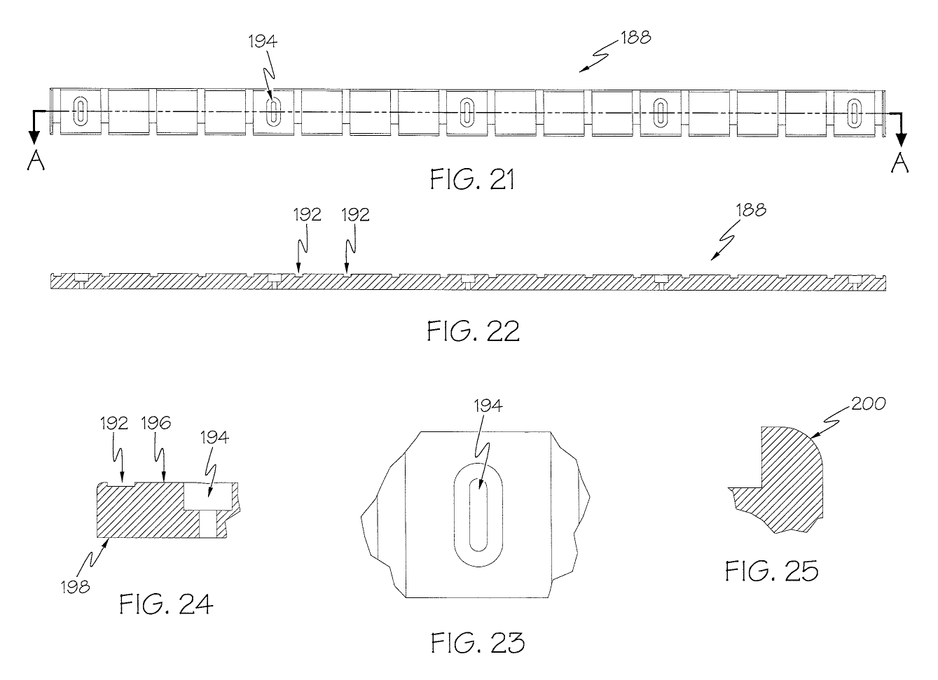

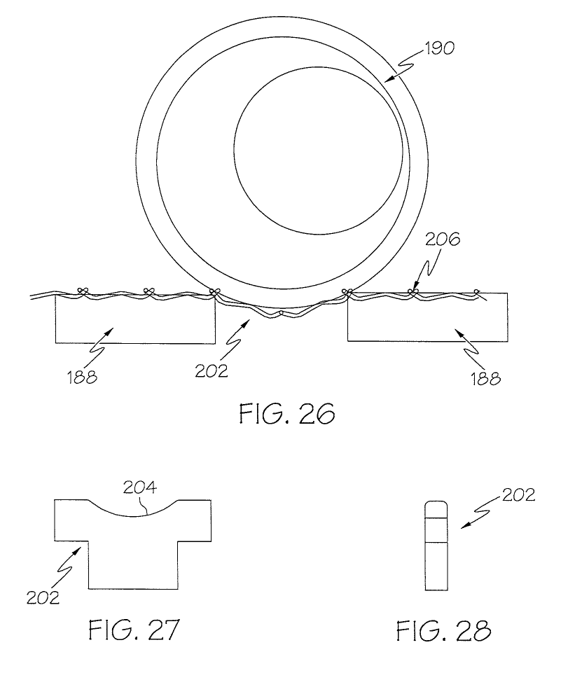

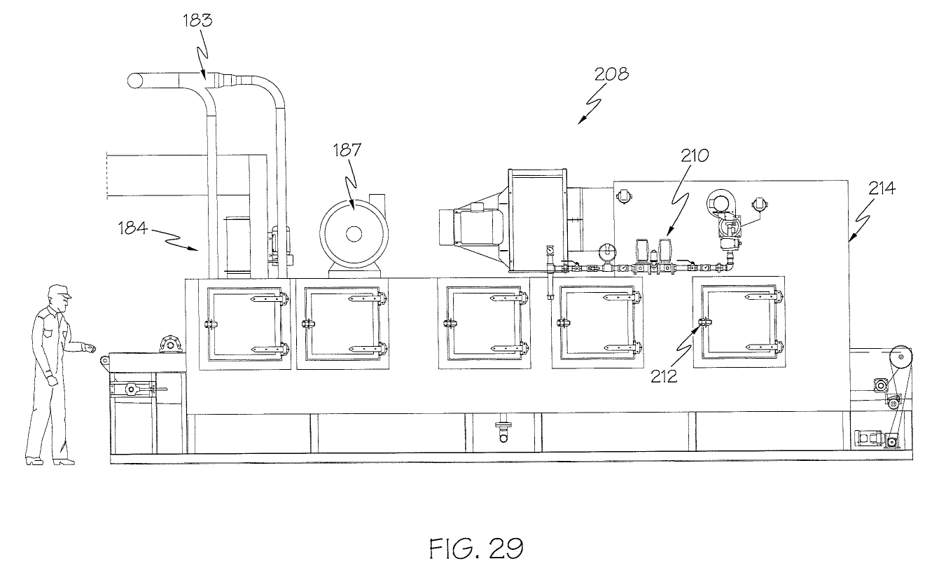

A vacuum (184), through which a mat may travel, may also be used to dry off a mat after the washing module (106). Such a vacuum (184) may be, for example, a two-zone vacuum. In addition, in one embodiment, vacuum (184) may comprise a nozzle block (188), a belt support (202), and a nozzle tube seal (190). As shown in FIGS. 19 and 29, vacuum (184) may also comprise plenum and piping (183), a wet cyclone separator (185), and a turbine fan (187). As shown in FIGS. 20-22, a nozzle block (188) may comprise a generally rectangular plate of suitable thickness with grooves (192) extending along the width of the plate. Nozzle block (188) may be manufactured out of any suitable material, for example, an ultra high molecular weight plastic. In addition, FIGS. 21 and 23 show that nozzle block (188) may comprise any number of countersunk and slotted mounting holes (194) As shown in FIG. 24, mounting hole (194) may not have a constant width as it extends through the generally rectangular plate of nozzle block (188) from a first surface (196) to a second surface (198). Moreover, nozzle block (188) may comprise a rounded edge (200) at the edge of the plate, as shown in FIG. 25. FIG. 26 shows that a nozzle tube seal (190) of vacuum (184) may be situated between two nozzle blocks (188), with a wire belt conveyor (206) positioned in between. Vacuum drying may be achieved when a static vacuum pressure is balanced with the airflow in nozzle block (188). For example, vacuum drying efficiency may be achieved through nozzle tube seal (190) when static vacuum pressure is a minimum of 5 inches of Hg and is balanced with a minimum of 20 CFM of airflow per inch of nozzle width.

Furthermore, a belt support (202) may be located in between the two nozzle blocks (188), as shown in FIG. 26. Belt support (202) may have a general T-shape as shown in FIG. 27-28, with a curved cutout (204) located in a surface of the belt-support (202), to support the wire belt conveyor (206). The curved surface (204) of the belt support (202) may also provide a curved conveyor belt path under vacuum. This curved path may open up the pile side or underside of a mat to improve the vacuum efficiency in addition to providing support for the conveyor belt (206) under vacuum.

The nozzle tube seal (190) is designed to allow a consistent vacuum pressure seal on any width mat by rotating and sealing above the wire conveyor belt (206) and nozzle bocks (188). This rotational sealing may allow a mat or any flat object to be vacuumed with a consistent vacuum draw on mats of any width. Further, the rotating seal may provide long service life due to rotation and negligible wear. The nozzle blocks (188) also may provide a mating seal surface for the nozzle tube seal (190). Nozzle blocks (188) may provide precise control of vacuum air flow and air velocity. As the mat is passing between the wire belt conveyor (206) and the nozzle tube seal (190), the vacuum air flow may remove substantial amounts of moisture. This moisture may be pulled through the nozzle plenum and piping (183) where it may then be separated from the airflow by a wet cyclone separator (185), as shown in FIG. 19. The separated moisture may also be collected and discharged or reused and the dry air flow may continue through a turbine fan (187).

In addition to a vacuum (184), drying module (108) may also comprise one or more other dryers (186). A typical dryer (186) may have a number of components, included but not limited to a turbine, a wet separator, a purge tank, and a nozzle. As will be appreciated by one of ordinary skill in the art, an suitable dryer or drying method may be used in the drying module (108). By way of example, dryer (186) could comprise one or more of the following: a cool air dryer, a high-volume, low-pressure dryer, a heated low velocity dryer, and a hot air dryer. In a preferred embodiment, a mat would encounter the following dryer mechanisms in a drying module (108): a cool air blow dryer, a vibrating beater, a vacuum dryer, a hot air dryer, and a cool down blower. An example of a hot air dryer (208) is shown in FIG. 29. Hot air dryer (208) may comprise a number of components including but not limited to a gas train (210), a thermocouple (212), and a sliding damper (214). Hot air dryer (208) may run at any suitable power, but preferably is run at 1 MMBTU. In addition, a dryer (186) and/or (208) may be operated at any suitable temperature. For example, dryer (186) may be operated up to 427 degrees F.

As with all other modules described herein, the components and methods described in the drying module (108) may be used in any suitable order as will be appreciated by one of ordinary skill in the art. By way of example, a mat entering the drying module (108) may encounter a vibratory beater (182) before proceeding along the conveyor (180). In another example, drying module (108) may comprise a wrinkle remover spreader roll, which may be engaged with a mat prior to a vacuum dry, to flatten the mat to improve drying efficiency. In addition, the components and methods of the drying module (108), like those of all other modules, may be practiced separately or in conjunction with one or more other components, methods, or modules. Of course, the above-described drying module (108) is merely one example. Any other suitable type of drying module (108) and associated components may be used. Drying module (108) may have any other suitable components, features, configurations, functionalities, operability, etc. Other suitable variations of drying module (108) and associated components will be apparent to those of ordinary skill in the art in view of the teachings herein.

### V. Discharge Module

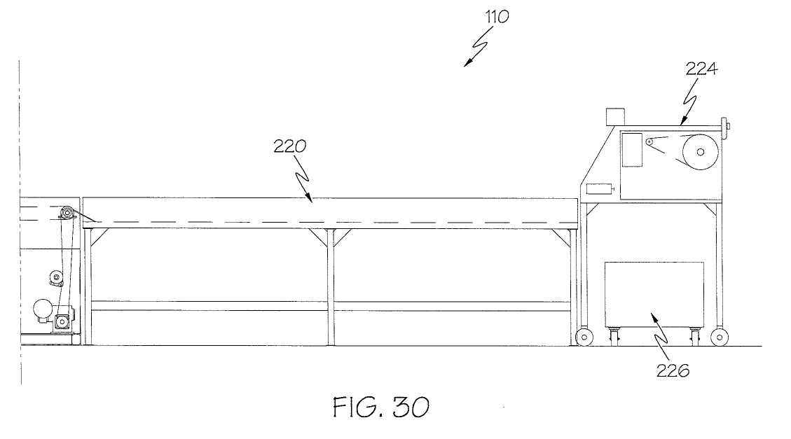

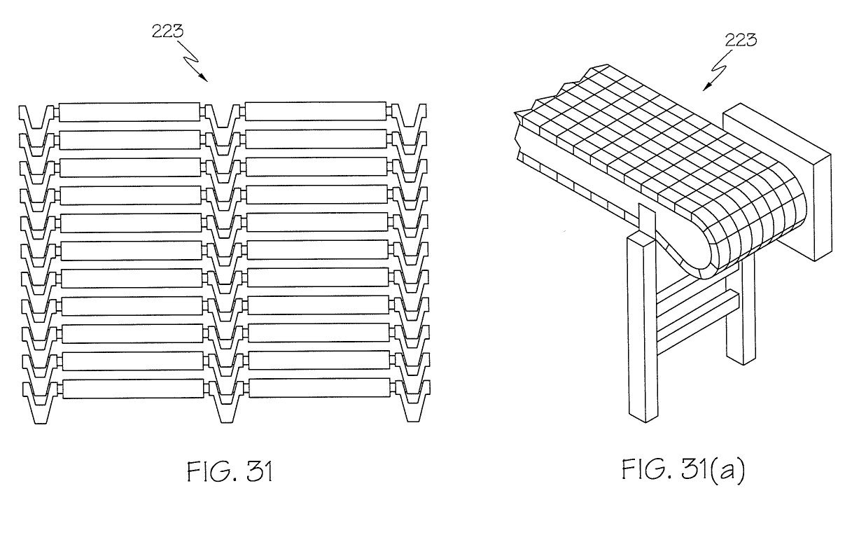

After the mat has been dried in drying module (108), the mat may exit the dryer (186) and be unloaded from the conveyor (180). A fifth module that the mat cleaning system (100) may comprise is the discharge module (110). For example, as shown in FIG. 30, after the mat exits the dryer (186) and is unloaded from the conveyor (180) in drying module (108), the mat may be fed onto a table (220) in the discharge module (110). Table (220) may be vibratory and used to hover the mat over the table (220) for transport and/or alignment of the mat. Alternatively, FIGS. 31-31(a) shows a dual action conveyor (222) upon which a mat may be fed in the discharge module (110). The dual action conveyor (222) may be driven with free spinning rollers (223) or vibratory rollers. The dual action aspect of either the free spinning rollers or the vibratory rollers may allow a mat to be discharged from a dryer (186) at a dryer conveyor speed and then transferred to an discharge module (110) at a different speed.

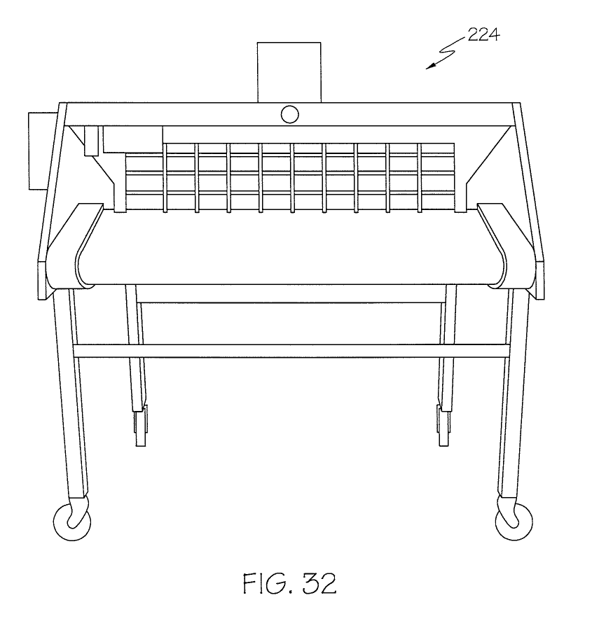

Discharge module (110) may also include an auto-roll discharge. The auto-roll discharge may be performed by an auto-roll discharge apparatus (224), as shown in FIG. 32. Such a discharge apparatus (224) may sort and roll the mats as they go through the discharge module (110). Such an automatic rolling system may reduce the number of people needed to operate the system (100). The discharge apparatus (224) may also sort according to any suitable factor as will be appreciated by one or ordinary skill in the art. For example, apparatus (224) may sort the mats according to size, weight, material type, or some other factor. After discharge, the mats may be placed in a mat cart (226). Alternatively, system (100) may include a manual sort.

Such a dual action conveyor (222) or a vibrating table (220) may permit a quality control inspection and a manual sort. As with the optional quality control inspection during the loading module (102), any suitable quality control inspection may be used during the discharge module (110). For example, the quality control inspection may include a review of the mat for tears, stains, worn spots, or any other quality-related issues. The inspection may include inspecting both sides of the entire mat. Alternatively, the inspection may only include inspecting either the pile side or the underside of the mat. Moreover, a quality control inspection may also include the treatment of stains or spots on the mat and/or the removal of damaged mats from the system (100).

Of course, the above-described discharge module (110) is merely one example. Any other suitable type of discharge module (110) and associated components may be used. By way of example only, discharge module (110) may not comprise an auto-roll discharge. As will other module components described herein, discharge apparatus (224) is merely optional, and may be modified, substituted, supplemented, or omitted as desired. Discharge module (110) may have any other suitable components, features, configurations, functionalities, operability, etc. Other suitable variations of washing module (106) and associated components will be apparent to those of ordinary skill in the art in view of the teachings herein.

Furthermore, the above-described system (100) is merely one example of a mat cleaning system. Any other suitable type of modules and associated components may be used. By way of example only, the above-mentioned modules may be modified, substituted, supplemented, re-ordered or omitted as desired. For example, system (100) may include additional safety features such as safety interlocks, guards, and/or e-stops on all moving parts. System (100) may have any other suitable components, features, configurations, functionalities, operability, etc. Other suitable variations of system (100) and associated components will be apparent to those of ordinary skill in the art in view of the teachings herein.

In the above-mentioned embodiments, the figures depict modules wherein the movement of the mat through the module was from left to right in a given figure. For example, the conveyor travel in FIG. 30 is generally from left to right. Such a direction is in no way intended and should not be used to limit the practicing of the invention.

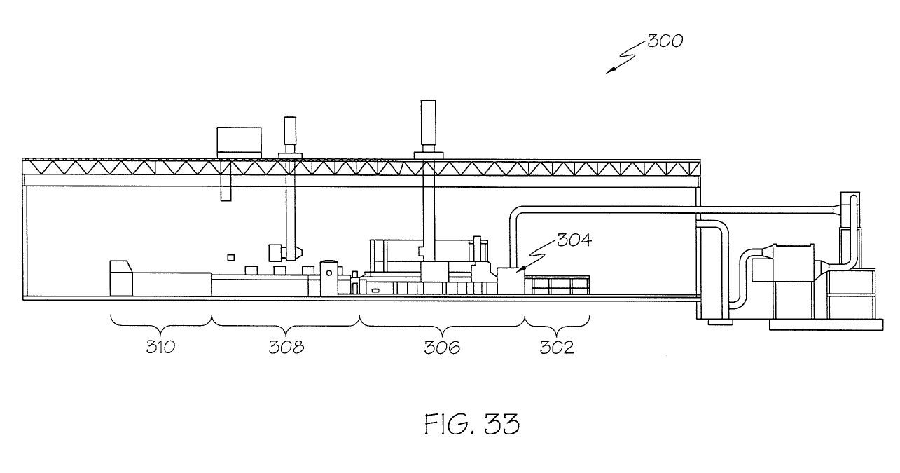

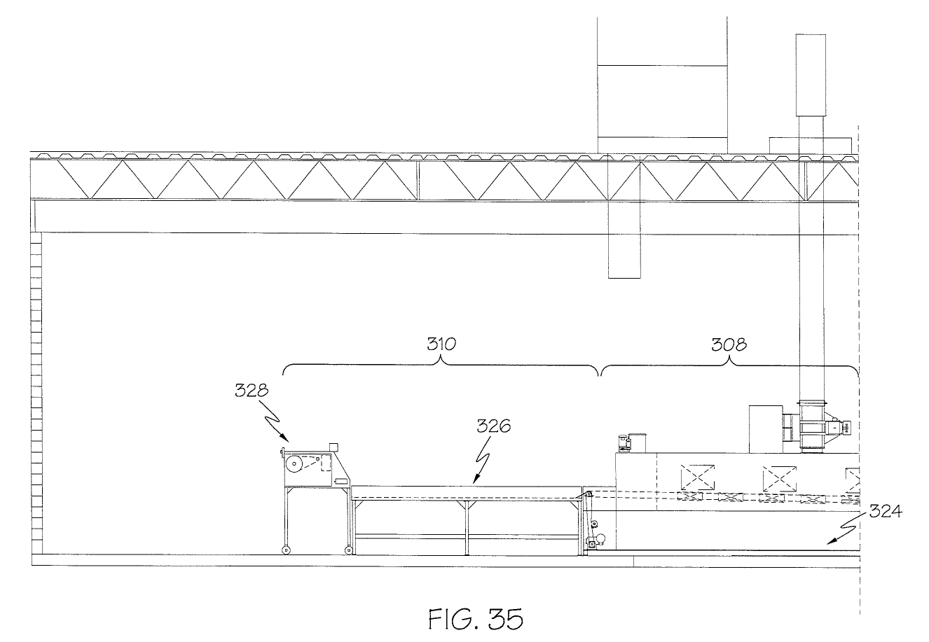

FIGS. 33-35 depict a particular embodiment of a mat cleaning system (300). Such a system also comprises a loading module (302), a vibration module (304), a washing module (306), a drying module (308), and a discharge module (310). The washing module (306) may comprise a number of different types of washes. For example, washing module (306) may include a high-volume, low-pressure wash (312), a high-volume, low-pressure rinse (314), a free rinse (316), and a high-volume, low-pressure blow dry, wherein air is blown around the mat to remove excess water or chemical wash remaining on a mat. The wash of the mat may be conducted with a chemical-based agent, whereas the rinses of the mat may be conducted with water. Drying module (308) may also comprise a number of sub-components including but not limited to a vibratory dryer (320), which comprises a vibratory beater that jostles the mat to dislodge an remaining water or chemical wash. A vacuum dryer (322) and a gas hot air dryer (324) may be included as part of the drying module (308). In addition, the discharge module (310) may comprise a dual action conveyor (326) and a discharge apparatus (328) for automatically rolling up the mats as they leave the system (300).

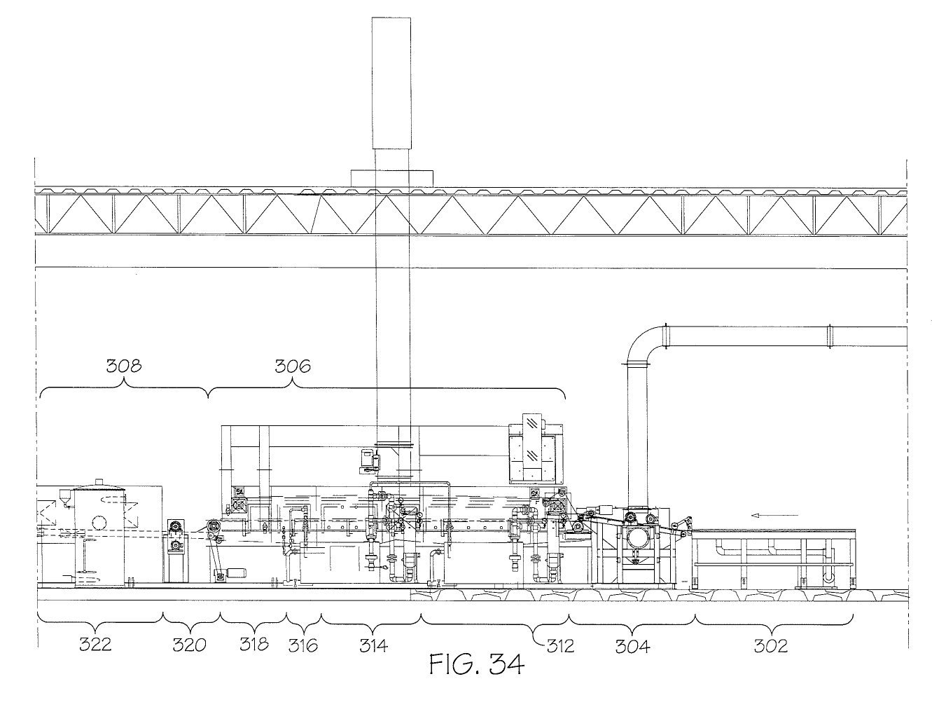

In the above-mentioned embodiments, the figures depicted modules wherein the movement of the mat through the module was from right to left in a given figure. For example, the conveyor travel in FIG. 34 is generally from right to left. Such a direction is in no way intended and should not be used to limit the practicing of the invention.

Of course, the above-described system (300) is merely one example of a mat cleaning system. Any other suitable type of modules and associated components may be used. By way of example only, the above-mentioned modules may be modified, substituted, supplemented, re-ordered or omitted as desired. System (300) may have any other suitable components, features, configurations, functionalities, operability, etc. Other suitable variations of system (300) and associated components will be apparent to those of ordinary skill in the art in view of the teachings herein.

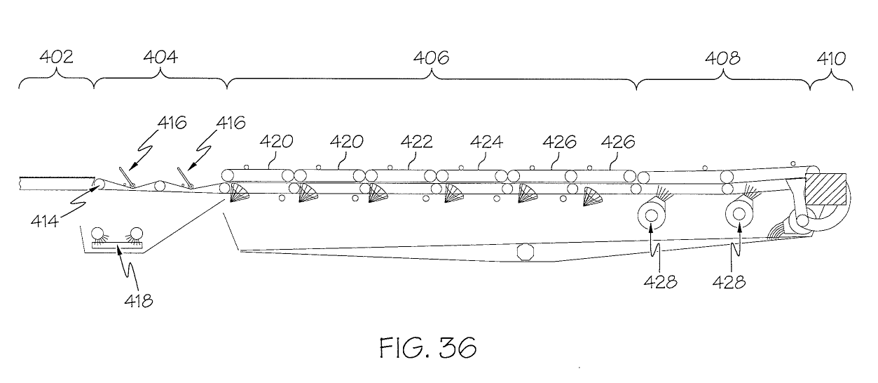

FIG. 36 depicts another particular embodiment of a system (400) for cleansing mats. In the embodiment shown in FIG. 36, the system (400) comprises loading module (402), a vibration module (404), a washing module (406), a drying module (408), and a discharge module (410). A mat may be first loaded onto a gravity roller table (412), which employs gravity to feed the mat into the system (400), in the loading module (402). The mat is loaded pile side down. A quality control inspection may be performed on the mat prior to its traveling by conveyor (414) to the next module.

As shown in FIG. 36, the mat moves to the vibration module (404), comprising two vibratory rollers (416), after leaving the loading module. Each vibratory roller (416) jostles or otherwise rattles the mat to cause dirt to become dislodged from the mat. This dirt falls into the dirt pan (418) positioned below the vibratory module (404). In addition to a dirt pan (418), a blower and a vacuum (not pictured) may be situated beneath vibratory module (404) to gather and dispose of the unwanted dirt.

After being subject to the vibratory module (404), the mat travels to the washing module (406), which may comprise a number of washes and/or rinses. As shown in FIG. 36, washing module (406) comprises two rinse cycles (420), followed by a first wash (422) and a second wash (424), followed by two rinse cycles (426). The mat may be washed using recycled water. Only during the first washing (422) is any type of chemical wash used. No chemical wash is used during the second washing (424). After the washing is complete, the mat is rinsed twice again (426). During the rinses (420, 426) multiple high volume, low pressure air nozzles may spray the mat to blow dirt from it.

After the washing module (406), the mat enters the drying module (408). Drying module (408) may comprise a blow dryer (428) and a dry vacuum (430). The mat may first be exposed to two blow dryers (428). After drying the mat using blow dryers (428), the dry vacuum (430) may be applied to the mat. After leaving the drying module (408), the mat may travels on the conveyor (414) to be sorted or otherwise handled as applicable during the discharge module (410).

Of course, the above-described system (400) is merely one example of a mat cleaning system. Any other suitable type of modules and associated components may be used. By way of example only, the above-mentioned modules may be modified, substituted, supplemented, re-ordered or omitted as desired. System (400) may have any other suitable components, features, configurations, functionalities, operability, etc. Other suitable variations of system (400) and associated components will be apparent to those of ordinary skill in the art in view of the teachings herein.

### Method of Cleaning Mats

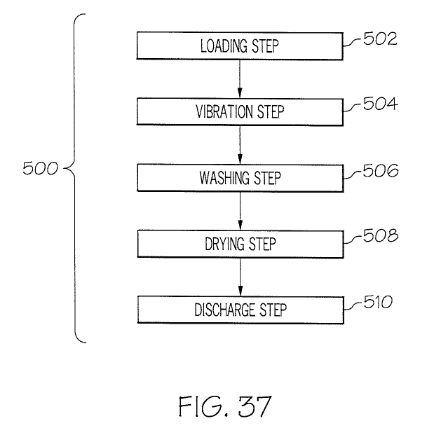

FIG. 37 displays a method (500) of cleaning mats. The above-mentioned disclosure relating to the various embodiments (100, 300, 400) of a mat cleaning system is incorporated herein by reference as if fully set forth again in full. Method (500) comprises a number of steps, each of which may be practiced separately or in combination with any of the other steps. As shown in FIG. 37, one method (500) of cleaning mats comprises a loading step (502), a vibration step (504), a washing step (506), a drying step (508), and a discharge step (510). During the loading step (502), a user may feed a mat into the system and onto a table, which may be, for example, an air-float table or a gravity roller table. Alternatively, a user may feed the mat onto a conveyor. During the loading step (502), the mat may be rotated or straightened out by a user or by load rollers or edge guides or the like. A user may also perform a quality control inspection of the mat prior to, during, or subsequent to feeding the mat onto the table or conveyor. Any suitable quality control inspection may be used. For example, the quality control inspection may include a review of the mat for tears, stains, or any other quality-related issues. The inspection may include inspecting both sides of the entire mat. Alternatively, the inspection may only include inspecting either the pile side or the underside of the mat. Even further, the inspection of the pile side of the mat may occur prior to flipping the mat pile side down and feeding the mat onto the table or conveyor. Inspection of the underside portion of the mat may occur after loading the mat onto the table or conveyor pile side down. Moreover, a quality control inspection may also include the pretreatment of stains or spots on the mat and/or the removal of damaged mats from the system.

After being fed through the loading step (502), the mat may be fed through the vibration step (504). For example, a mat may be transported from an air-float table or gravity roller table and positioned onto a conveyor. There, the mat may be shaken or jostled due to the movement of the conveyor. This may cause dirt to be loosened or dislodged from the mat. During the vibration step (504), the mat may also be fed through contact with at least one beat roller assembly. Contact with the beat roller assembly may also cause any dirt located on or in the mat to be loosened or dislodged. The loosened and/or dislodged dirt may be collected. For example, a dirt collector pan may be placed underneath the conveyor to collect the dirt that falls from the mat during the vibratory step (504). A vacuum or equivalent device may also be placed near the conveyor to collect the dirt from the mat.

After the dirt and loosened from the mat and collected during the vibration step (504), the mat may be fed through the washing step (506). There, the mat may continue along on a conveyor. During the washing step (504), the mat may undergo one or more washes and/or rinses. For example, the mat may first be washed with a chemical-based agent using a high volume, low pressure nozzle. After one or more chemical washes, the mat may be rinsed one or more times with water. The water may be reused and recycled in the washing step (506). The reused water may be collected in any suitable manner. The recycled water may be cleaned prior to its future use. Alternatively, the mat may be rinsed one or more times before it is washed. In addition, after washing and rinsing the mat, washing step (506) may include blowing air or another gas over and around the mat to remove an water or chemical agent remaining on the mat.

After the mat is washed and rinsed in the washing step (506), the mat may be fed through the drying step (508). This step may comprise a number of sub-steps, including but not limited to vibrating the mat with a conveyor and/or a beater, passing the mat through a vacuum, and passing the mat through one or more dryers. The vacuum may be separate from the dryer or may be part of a dryer, for example a vacuum dryer. Other dryers that may be employed during the drying step (508) include but should not be limited to: a cool air dryer, a high-volume, low-pressure dryer, a heated low velocity dryer, and a hot air dryer. A mat may be fed through the sub-steps of the drying step (508) in any suitable order as will be apparent to one of ordinary skill in the art. For example, the mat may be fed through a dryer first and then fed through a vacuum.

After the mat is fed through the drying step (508), it may be unloaded from the conveyor. The mat may be placed on a table or a dual action conveyor as part of the discharge step (510). The discharge step (510) comprises sub-steps related to discharging, rolling, and sorting mats from the system. For example, the discharge step (510) may include rolling the mats as they exit the conveyor or table. Discharge step (510) may also comprise a sorting step, whereby the mat is either manually or automatically sorted according to any suitable factor, such as size, weight, material type, etc. After discharge, the mat may be placed in a mat cart for storage or transport. In addition to rolling and/or sorting, the discharge step (510) may comprise a quality control inspection. For example, the quality control inspection may include a review of the mat for tears, stains, or any other quality-related issues. The inspection may include inspecting both sides of the entire mat. Alternatively, the inspection may only include inspecting either the pile side or the underside of the mat. Moreover, a quality control inspection may also include the treatment of stains or spots on the mat and/or the removal of damaged mats from the system.

Of course, the above-described method (500) is merely one example of a mat cleaning process. The process (500) may comprise any other suitable steps and modules and associated components. By way of example only, the above-mentioned steps may be modified, substituted, supplemented, re-ordered or omitted as desired. Method (500) may have any other suitable steps, actions, components, features, configurations, functionalities, operability, etc. Other suitable variations of method (500) and associated steps will be apparent to those of ordinary skill in the art in view of the teachings herein.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, materials, steps, and the like discussed above are illustrative and are not required. Accordingly, the scope of the present invention should not to be limited to the details of structure and operation shown and described in the specification and drawings.

What is claimed is:

1. A cleaning system for a flat object, comprising:
(a) a loading module for feeding the flat object onto a conveyor;
(b) a vibration module for contacting the flat object with at least one at least one beat roller to dislodge matter from the flat object;
(c) a washing module for washing and rinsing the flat object;
(d) a drying module for drying the flat object; and
(e) a discharge module for unloading the flat object from the system.

2. The cleaning system of claim 1, wherein the flat object is a mat.

3. The cleaning system of claim 2 wherein
(a) the loading module further comprises a table upon which the mat may lay;
(b) the vibration module further comprises a conveyor and at least one beat roller, wherein the conveyor extends from the table of the loading module;
(c) the washing module further comprises a conveyor, at least one washing instrument, and at least one rinsing instrument, wherein the conveyor extends from the conveyor of the vibration module;
(d) the drying module further comprises a conveyor, at least one vibrating beater, and at least one dryer, wherein the conveyor of the drying module extends from the conveyor of the washing module; and
(e) the discharge module further comprises a dual-action conveyor and a discharge apparatus, wherein the dual-action conveyor extends from the conveyor of the drying module.

4. The cleaning system of claim 3, wherein the table of the loading module is an air-float table having a plurality of holes extending through the table, through which air may be blown for ergonomic feeding of the mat.

5. The cleaning system of claim 4, further comprising a collection trough situated beneath the air-float table to collect the dirt.

6. The cleaning system of claim 3, wherein the table of the loading module is a gravity roller table.

7. The cleaning system of claim 3, wherein the table of the loading module further comprises at least one load roller that is rotatable to straighten out the flat object that is laid upon the table.

8. The cleaning system of claim 3, wherein the washing module further comprises a high-volume, low-pressure nozzle through which the washing solution and the rinsing solution may be sprayed.

9. The cleaning system of claim 3, wherein the discharge apparatus of the discharge module rolls the flat object as it leaves the system.

10. The cleaning system of claim 7, wherein the discharge apparatus sorts the flat object as it leaves the system.

11. A vibration module for jostling a flat object, comprising:
(a) a conveyor upon which the flat object may lay; and
(b) at least one beat roller, the at least one beat roller comprising a substantially cylindrical shaft that defines a central bore;
wherein the rotation of the at least one beat roller brings it in contact with the flat object.

12. The vibration module of claim 11, wherein the at least one beat roller is part of a beat roller assembly, the beat roller assembly comprising:
(a) a generally cylindrical shaft;
(b) a support plate having a central cavity and a plurality of periphery holes, the generally cylindrical shaft being positioned through the central cavity; and
(c) at least one beat roller having a first end and a second end and a pair of sealed, high speed bearings, the either of the first end or the second end being secured to the support plate through one of the plurality of periphery holes.

13. The vibration module of claim 11 further comprising a dirt collector positioned to collect dirt falling from the conveyor.

14. A drying module for drying a flat object, comprising:
(a) a conveyor upon which the flat object may lay, the conveyor being capable of vibrating at a frequency;
(b) at least one vibratory beater, the at least one vibratory beater comprising a substantially cylindrical shaft that defines a central bore, wherein the rotation of the at least one vibratory beater brings it in contact with the conveyor; and
(c) a dryer into which the conveyor and the at least one vibratory beater are positioned, wherein the dryer is selected from the group consisting of: a cool air dryer; a vacuum dryer; a high-volume, hot air dryer; a cool down blower; and combinations thereof.

15. A method for cleaning a flat object comprising subjecting the flat object to the following steps:
(a) a loading module;
(b) a vibration module;
(c) a washing module;
(d) a drying module; and
(e) a discharge module.

16. The method of claim 15, wherein the flat object is a mat.

17. The method of claim 16, further comprising inspecting the flat object for wear or damage.

18. The method of claim 16, further comprising directing the flat object into contact with at least one beat roller.

19. The method of claim 16, wherein the drying step further comprises using at least one vacuum.

20. The method of claim 16, further comprising rolling the flat object.

21. The method of claim 16, further comprising sorting the flat object according to criteria selected from the group consisting of:
(a) size;
(b) weight; and
(c) material type.
